(19) United States
(12) Patent Application Publication
(10) Pub. No.: US 2026/0252666 A1
(43) Pub. Date: Aug. 27, 2026

(54) SYSTEMS AND METHODS FOR CLASSIFYING A DATA SOURCE CONTAINING STRING VALUES

(71) Applicant: IMMUTA, INC., College Park, MD (US)

(72) Inventors: Arthur J. NEUMAN, III, Columbus, OH (US); Joseph J. REGENSBURGER, Grove City, OH (US); Alfred V. ROSSI, III, Dublin, OH (US)

(21) Appl. No.: 19/548,475

(22) Filed: Feb. 24, 2026

Related U.S. Application Data
(60) Provisional application No. 63/762,373, filed on Feb. 24, 2025.

(51) Int. Cl. G06F 18/2415; G06F 18/2431

(52) U.S. Cl. CPC G06F 18/2415; G06F 18/2431

(57) ABSTRACT

A method and system are configured to sample a plurality of strings from a data source, the data source having an unknown classification, construct an empirical Hankel matrix from the strings, generate an embedding of the data source in a k-dimensional space by extracting the top k singular values of the empirical Hankel matrix, repeat the sampling, constructing, and computing steps over n independent trials to produce n signature vectors, and aggregating the n signature vectors into a mean vector and a standard deviation vector to create a query point associated with the data source, query a memory with the query point, the memory storing known embeddings, each known embedding comprising a respective known mean vector and a respective known standard deviation vector having a known classification label, to estimate, for the query point, a similarity measure to the known embeddings, and generate the classification label as a proposed classification of the data source responsive to the similarity measure exceeding a predetermined threshold.

### CROSS-REFERENCE TO RELATED APPLICATIONS

This application claims the benefit of U.S. Provisional Patent Application No. 63/762,373 filed on Feb. 24, 2025, which is hereby incorporated by reference in its entirety.

### FIELD OF THE DISCLOSURE

The techniques herein generally relate to classifying a data source containing string values, and more particularly, but not exclusively, to systems and methods for determining a proposed classification label for the data source.

### BACKGROUND

In many applications, string collections of data (such as may be in a database) may need to be categorized or identified by their content. For instance, there may be a need to determine whether a database has any tables with columns containing phone numbers, email addresses, postal codes, or other types of data that may be classified with a classification label.

One common approach with categorizing string data in such a database is to associate each identification category with a carefully crafted regular expression and then measure each column's consistency with each pattern. For example, the following are common types of data that may be categorized: 1) telephone number, a common US telephone number may appear as having a three-digit area code enclosed in parentheses, followed by a space, a three-digit number, a hyphen, and four more digits, the corresponding regular expression is (\d{3})\d{3}-\d{4}; 2) US postal code, a postal code may appear as five numeric digits and could be found by checking consistency against five numeric digits, optionally followed by a dash and four more digits, the corresponding regular expression is \d{5}(−\d{4})?; and 3) email address, a (simplified) pattern that captures a typical email address might look like a local part, an @ symbol, and then something resembling a domain, the corresponding regular expression could be [a−z0−9.*%+−]+@[a−z0−9·−]+·[a−z]{2,}.

Despite being conceptually straightforward, pattern-based identification of string data with such categorization remains cumbersome in practice. For example, it is difficult to capture all plausibly present variations in a single pattern from the outset, leading to subsequent issues that may need modification. Moreover, despite its ubiquity, regular expression syntax is terse, notoriously challenging to read, and extremely sensitive to minor errors. Debugging and editing, therefore, require a certain level of technical expertise, limiting the utility of such tools to a general audience.

Given these difficulties, it is desired to enable training such a system to propose such categorization for string data in a data source without a user having to have the knowledge and training needed for utilizing such regular expressions or other complex methods of classification of data strings.

### SUMMARY

Disclosed herein are systems, methods, and non-transitory computer-readable medium products for classifying a data source containing string values.

In some embodiments, the systems, methods, and computer program products may sample a plurality of strings from the data source, the data source having an unknown classification, construct an empirical Hankel matrix from the strings, generate an embedding of the data source in a k-dimensional space by extracting the top k singular values of the empirical Hankel matrix, repeat the sampling, constructing, and computing steps over n independent trials to produce n signature vectors, and aggregating the n signature vectors into a mean vector and a standard deviation vector, query a memory with the query point, the memory storing known embeddings, each known embedding comprising a respective known mean vector and a respective known standard deviation vector having a known classification label, to estimate, for the query point, a similarity measure to the known embeddings, and generate a classification label as a proposed classification of the data source responsive to the similarity measure exceeding a predetermined threshold.

In some embodiments, for each of the sampled string values, characters may be replaced according to a character-class mapping to produce normalized strings.

In some embodiments, the empirical Hankel matrix is constructed from substring co-occurrence counts of the normalized strings, wherein each entry of the Hankel matrix records a count of co-occurrences of a prefix-suffix pair across substrings of the normalized strings up to a predetermined length limit.

In some embodiments, the mean vector and the standard deviation vector of the data source associated with the generated classification label may be stored in the memory store.

In some embodiments, the predetermined threshold may be settable by a user.

### BRIEF DESCRIPTION OF THE DRAWINGS

The accompanying drawings, which are incorporated into and constitute a part of this specification, illustrate implementations of the techniques herein and together with the description, serve to explain the principles of various embodiments.

FIG. 1 illustrates a block diagram of an example of an environment for implementing systems and methods in accordance with aspects of the present disclosure.

FIG. 2 shows a system block diagram illustrating an example of a computing system, in accordance with aspects of the present disclosure.

FIG. 3 is a flowchart of a process consistent with implementations described herein.

FIG. 4 is a flowchart of a process consistent with implementations described herein.

FIG. 5 is a flowchart of a remember process consistent with implementations described herein.

FIG. 6 is a flowchart of a query memory process consistent with implementations described herein.

FIG. 7 is a flowchart of an identify process consistent with implementations described herein.

FIG. 8 is a flowchart of an untag process consistent with implementations described herein.

FIG. 9 is a chart of representative samples of a per sample average consistent with implementations described herein.

FIG. 10 is a graph illustrating an entry in a memory after a remember process consistent with implementations described herein.

FIG. 11 is a graph illustrating two embeddings in a memory after a remember process consistent with implementations described herein.

FIG. 12 is a graph illustrating entries in a memory after an identify process consistent with implementations described herein.

FIG. 13 is a graph illustrating entries in a memory after an untag process consistent with implementations described herein.

### DETAILED DESCRIPTION

Reference will now be made in detail to example implementations of the techniques herein, examples of which are illustrated in the accompanying drawings. Wherever convenient, the same reference numbers will be used throughout the drawing to refer to the same or like parts.

In accordance with embodiments described herein, a system, processes and non-transitory computer-readable medium may be configured for classifying a data source containing string values. The systems and processes may classify the data source containing string values as further described herein.

In accordance with various embodiments, the administrators or users of the data source do not have to understand how to classify the data source containing string values, which can be difficult. For example, classifying a data source containing string values may require use and manipulation of regular expressions or the use of other conceptually difficult and computationally intensive processes, requiring a user trained in these difficult areas.

Instead, the embodiments described herein may be configured to generate the classification of the data source containing data strings by sampling the data source and determining the classification without the need for the user to understand or be able to utilize the complex conventional processes that are typically needed for the classification of the data source.

The embodiments disclosed herein provide an improvement to conventional data source and database technology by providing the disclosed systems and methods that are configured to automatically generate a classification of a data source containing data strings. Such classification may be difficult and may require use of complex Hankel matrices, normalization techniques, etc. This allows a user of the data source to automatically receive a classification of the string or strings without the user of the data source having to know how to determine the classification.

Formal language theory shows that regular expressions are equivalent to two classes of finite state machines (FSMs), which are in turn equivalent to each other: 1) Deterministic Finite Automata (or DFAs), and 2) Non-Deterministic Finite Automata (NFAs). These classes of state machines have well-defined algebraic properties that allow for systematic manipulation. For example, a DFA that recognizes the complement language may be constructed by interchanging accepting and non-accepting states, while unions and intersections may be implemented through product constructions. Moreover, conversion may be freely made between regular expressions and corresponding state machine representations. It is, therefore, possible to systematically edit regular expressions by converting to an equivalent form in a convenient class of FSM, performing appropriate state machine algebra, and converting back to a regular expression.

It follows that if a state machine representation of a desired change may somehow be inferred, as a pair (M_{P},M_{N}), where M_{P} is a “positive” state machine that matches “missed” strings, and M_{N} is a “negative” state machine that matches “incorrect” strings to be removed from M, then M may be corrected through the update rule:: M←(M∪M_{P})−M_{N}. Here, state machine subtraction for a pair of state machines M₁, and M₂, is achieved through De Morgan's laws, specifically, M₁−M₂=M₁∩M̅₂, where M̅₂ denotes a state machine matching the complement language.

There are a couple of difficulties with this approach. Not only is it somewhat computationally intensive, but there can be quite a dramatic increase in the size of a regular expression, which is not only due to product constructions but also to conversion between regular expression and state machine representations. Typically, pattern length increases, and despite being guaranteed an equivalent representation, there is no guarantee to find a small one.

Putting aside the size problem, there is a question of how to decide what to apply. The most straightforward update would add exactly those missing values while removing exact specific values that should not be there. For an example of why this may not be desirable, consider the case of US Phone Number being extended to cover UK Phone Number, where the US Phone Number regular expression pattern above is \d{5}(−\d{4})?. Upon correcting over data which contains a UK Phone Number +44 (020) 1234 5678, there would be a tendency to update the state machine to match exactly this (and no other UK phone numbers not present in the data). Therefore, an update could be added that generalizes from the examples, so that something approximating a rule like +44 (020)\d{4}\d{4} may be used when there are several examples with this same prefix. Though the preceding example used addition, similar problems exist with subtraction where removing a match would only remove a specific match.

Encoding many specific examples (or counter-examples, as the case may be) within the state machine itself drastically increases its size. Constraining the inferred state machine's complexity (i.e., size) forces generalization to occur.

### State Machine Inference

Generically, an identifier is a boolean function on strings that returns true if and only if a given string is consistent with an identifier. For example, a function for US Phone Number would return True for the string (123) 456-7890, and False for the string +44 (020)\d{4}\d{4}.

Based on this insight, shifting the view of state machines from combinatorial models of pattern-matching processes to representations of boolean functions over strings may be made. Furthermore, this results in a method to quantify the complexity of boolean functions of strings in terms of the size (number of nodes) of a smallest equivalent DFA.

Given any DFA, including a DFA that is larger than necessary, a minimal equivalent DFA can be found in O(n|Σ|log(n))-time by Hopcroft's Algorithm, where n is the number of nodes in the input DFA and |Σ| denotes the size of the alphabet. Therefore, assuming a fixed alphabet, the complexity of any boolean-valued string function in DFA form may also be found in near-linear time in the DFAs size.

Rather than considering only boolean-valued string functions, real-valued ones can be considered. These are, of course, equivalent to boolean-valued functions where the value 1 corresponds to True and 0 corresponds to False. Functions mapping strings over an alphabet Σ to the real numbers are known as formal series.

The corresponding state machine model can also be generalized to accommodate real-valued output. The result is a class of automata known as weighted finite automata (or WFA). A WFA comprises a set of states, a pair of real-valued vectors over these states representing initial and final weights for each state, and a real-valued transition matrix for each letter in the alphabet.

Fliess' Theorem then shows that something analogous holds for weighted automata. Namely, for any formal series f:Σ→R, the rank of the so-called “Hankel matrix” of f, a bi-infinite string-indexed matrix H(u,v)=f(uv), is equal to the number of states in a minimal WFA computing f. Moreover, a minimal WFA for f may be recovered through factorization of its Hankel matrix.

This leads naturally to the approach, as discussed in Balle: A Hankel matrix for a target function f is empirically estimated from data and then factorized to give a state machine approximating f. If the target function is indeed computable by a WFA, the error between the approximation and f is bounded.

However, this approach has practical difficulties in the problem context. First, it requires a lot of data to obtain sufficient convergence to the target function f, and users may simply not have enough data available to obtain useful output. Second, Hankel matrices for suitable target objectives tend to get large quickly, often too large to hold in memory. Third, matrix factorization is fairly resource-intensive and proves prohibitive without controlling Hankel matrix size.

For all of the problems above, a solution that is needed that avoids state machine inference and direct adjustment of regular-expression-defined patterns. Instead, that all information needed to reconstruct the WFA of f must already be present in the corresponding Hankel matrix.

Moreover, Hankel matrices are robust to sampling when the objective function realizes a probability distribution. Therefore, any stable function of a Hankel matrix rich enough to recover, say, a WFA computing the probability that any given string appears, can act as a signature of the underlying WFA.

In particular, if representable f₀ and f₁ realize probability distributions, and ∥f₀−f₁∥, then ∥H₀−H₁∥_{F}∈O(\sqrt{δ}). It is observed that

$${‖ {H}_{0} - {H}_{1} ‖}_{F}^{2} = {\sum }_{u , v} {( {f}_{0} ( uv ) - {f}_{1} ( uv ) )}^{2} \leq {\sum }_{u , v} \vert {f}_{0} ( uv ) - {f}_{1} ( uv ) \vert ,$$

where the last inequality holds because 0≤f₀(x),f₁(x)≤1. Let x denote an arbitrary string and observe that x may be partitioned into pairs of the form uᵢvᵢ=x exactly |x|+1 ways. It follows that:

$${\sum }_{u , v} \vert {f}_{0} ( u v ) - {f}_{1} ( uv ) \vert = {\sum }_{x} ( \vert x \vert + 1 ) \vert {f}_{0} ( x ) - {f}_{1} ( x ) \vert .$$

Observe that for Some Constant, K,

$${‖ {H}_{0} - {H}_{1} ‖}_{F}^{2} \leq {\sum }_{x \leq K} ( \vert x \vert + 1 ) \vert {f}_{0} ( x ) - {f}_{1} ( x ) \vert + {\sum }_{\vert x \vert > K} ( \vert x \vert + 1 ) ( {f}_{0} ( x ) + {f}_{1} ( x ) ) \vert ,$$

where we have split the sum and applied the triangle inequality to the second term. Therefore,

$${‖ {H}_{0} - {H}_{1} ‖}_{F}^{2} \leq ( K + 1 ) δ + ϵ ,$$

where the first term comes from the fact that |f₀(x)−f₁(x)|≤δ, and the second term follows from the fact that all representable probability distributions must be sub-exponential. In other words, there exist constants cᵢ, such that fᵢ(x)∈O(exp(−cᵢ|x|)) for i∈{0,1}.

When σ is Lipschitz for some constant, L, ∥σ(H₀)−σ(H₁)∥≤H₀−H₁∥_{F}, which is again O(√δ).

In particular, let σᵢ(H) denote the i-th singular value of H in non-increasing order, and let σ(H)=(σ₁(H), σ₂(H), . . . , σₖ(H)). Then, by the Hoffman-Wielandt inequality,

$${‖ σ ( {H}_{0} ) - σ ( {H}_{1} ) ‖}_{2}^{2} = {\sum }_{i = 1}^{k} {( {σ}_{i} ( {H}_{0} ) - {σ}_{i} ( {H}_{1} ) )}^{2} \leq {‖ {H}_{0} - {H}_{1} ‖}_{F}^{2} .$$

In summary, the embedding H into [symbol] by its top k singular values is 1-Lipschitz, and it in turn follows that ∥σ(H₀)−σ(H₁)∥₂∈O(\sqrt{δ}).

If realizable distributions are close, so are the Euclidean space embeddings given by the top k singular values of their corresponding Hankel matrices.

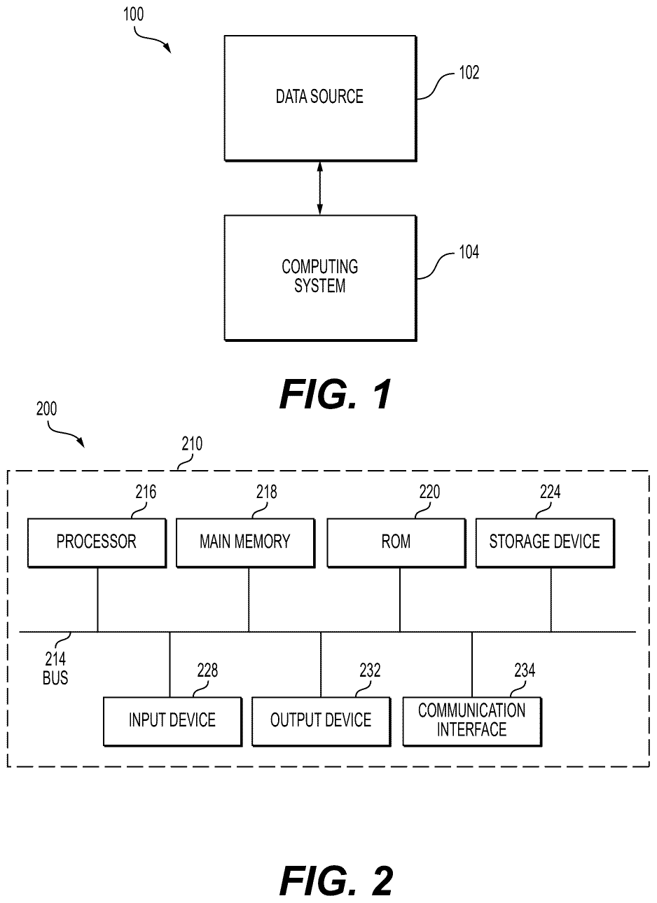

FIG. 1 illustrates a block diagram of an example of a system or an environment 100 for implementing systems and methods in accordance with aspects of the present disclosure. The environment 100 may include a data source system 102 (also called simply data source 102), and a computing system 104. In some embodiments the data source 102 may be a database such as an SQL database.

In one usage example, a user (not shown) may use the computing system 104 to access data in the data source 102. Computing system 104, in accordance with aspects of the present disclosure, may be configured to access data strings in the data source 102 and propose a classification for the data in the data source 102, as further described herein.

While FIG. 1 illustrates computing system 104 configured to access the data strings in the data source 102 to propose a classification for the data in the data source 102, in some embodiments, the functionality of the computing system could be carried out by a processor in the data source itself.

FIG. 2 shows a system block diagram illustrating an example of further details that may be present in the computing system 104 of FIG. 1, illustrated as computing system 200, in accordance with aspects of the present disclosure. As shown in this example, the computing system 200 may include a computing device 210 capable of communicating via a network, such as the Internet. In example embodiments, the computing device 210 may correspond to a mobile communications device (e.g., a smart phone or a personal digital assistant (PDA)), a portable computer device (e.g., a laptop or a tablet computer), a desktop computing device, a server, etc. In some embodiments, the computing device 210 may host programming and/or an application(s) to carry out the processes, methods, functions, or operations as described herein. For example, the computing device 210 may be configured to receive and/or obtain a data from the data source 102 via its communications interface 234.

The computing device 210 may include a bus 214, a processor 216, a main memory 218, a read only memory (ROM) 220, a storage device 224, an input device 228, an output device 232, and a communication interface 234, as shown in this example.

The bus 214 may be or include a path that permits communication among the components of the computing device 210. The processor 216 may be or include a processor, a microprocessor, an application specific integrated circuit (ASIC), a field programmable gate array (FPGA), or another type of processor that interprets and executes instructions. The main memory 218 may include a random-access memory (RAM) or another type of dynamic storage device that stores information or instructions for execution by the processor 216. The ROM 220 may be or include a static storage device that stores static information or instructions for use by the processor 216. The storage device 224 may include a magnetic storage medium, such as a hard disk drive, or a solid state memory device, which may be removable, such as a flash memory.

The input device 228 may include a component(s) that permits an operator to input information to computing device 210, such as a control button, a keyboard, a keypad, a mouse, a microphone, a touchscreen, or another type of input device. The output device 232 may include a component(s) that outputs information to an operator or user, such as a light emitting diode (LED), a display, a monitor, a touchscreen, or another type of output device. The communication interface 234 may include any transceiver-like component that enables the computing device 210 to communicate with other devices or networks. In some implementations, the communication interface 234 may include a wireless interface, a wired interface, or a combination of a wireless interface and a wired interface. In embodiments, the communication interface 234 may receive computer readable program instructions from a network and may forward the computer readable program instructions for storage in a computer readable storage medium (e.g., storage device 224, main memory 218, etc.).

The system 200 may perform certain operations, as described in detail herein. The system 200 may perform these operations as, or in response to, the processor 216 executing software instructions contained in a computer-readable medium, such as the main memory 218. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into the main memory 218 from another computer-readable medium, such as the storage device 224, or from another device via communication interface 234. The software instructions contained in the main memory 218 may direct the processor 216 to perform the processes, methods, or operations that are described in greater detail herein. Alternatively, hardwired circuitry may be used in place of or in combination with software instructions to implement processes, methods, or operations described herein. Thus, implementations described herein are not limited to any specific combination of hardware circuitry and software.

In some implementations, the system 200 may include additional components, fewer components, different components, or differently arranged components than are shown in FIG. 2.

The system 200 may be connected to a communications network (not shown), which may include one or more wired and/or wireless networks. For example, the communications network may include a cellular network (e.g., a second generation (2G) network, a third generation (3G) network, a fourth generation (4G) network, a fifth generation (2G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the communications network may include copper transmission cables, optical transmission fibers, wireless transmission, routers, firewalls, switches, gateway computers and/or edge servers.

The computing device 210 shown in FIG. 2 may be configured to receive or obtain data from the data source 102 and provide a classification, such as a classification label for the data, as further described herein.

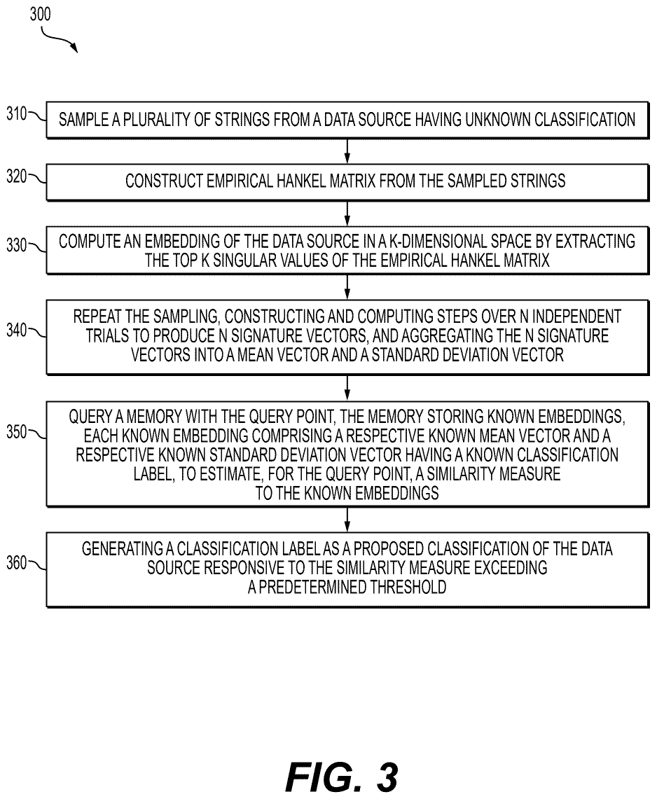

FIG. 3 illustrates an example of a process or method 300 that may be carried out by systems and methods described herein, configured to generate a classification, such as a classification label, for data in the data source 102, consistent with embodiments of the invention. The process 300 begins in 310 by the computing device 104 sampling a plurality of strings from the data source, the data source having an unknown classification. The strings may be received or obtained as data strings from the data source 102. The strings may be received at or obtained by the computing device 104 from the data source 102, or the computing device 104 may receive the strings directly or indirectly from the data source 102. In various embodiments, the data source 102 may be a database or other data source.

In some embodiments, for each sampled string value, the computing device may be configured to replace characters in the sampled data string according to a character-class mapping to produce a normalized string. In some embodiments, this step may be omitted.

In 320, the computing device 104 may be configured to construct an empirical Hankel matrix from the strings. In some embodiments, when a normalized string is produced, substring co-occurrence counts of the normalized strings may be used to construct the empirical Hankel matrix. In these embodiments, each entry of the Hankel matrix records a count of co-occurrences of a prefix-suffix pair across substrings of the normalized strings up to a predetermined length limit.

In 330, the computing device 104 may be configured to compute an embedding of the data source 102 in a k-dimensional space by extracting the top k singular values of the empirical Hankel matrix.

In 340, the computing device 102 may be configured to repeat the sampling, constructing, and computing steps over n independent trials to produce n signature vectors, and aggregate the n signature vectors into a mean vector and a standard deviation vector to create a query point associated with the data source.

In 350, the computing device 102 may be configured to query a memory with the query point, the memory storing known embeddings, each known embedding comprising a respective known mean vector and a respective known standard deviation vector having a known classification label, to estimate, for the query point, a similarity measure to the known embeddings.

In 360, the computing device 102 may be configured to generate the classification label as a proposed classification of the data source responsive to the similarity measure exceeding the predetermined threshold. In some embodiments, the similarity measure may be determined by comparing known mean vector and a known stored standard deviation vector for each stored embedding, to the standard deviation vector of the data source and determining a similarity thereto. In some embodiments, the predetermined threshold may be settable by a user.

A tagging process is disclosed for classifying or tagging data, EXTERNAL IDENTIFICATION, with memory M that associates classification decisions with regions of signature space. Before making any request to EXTERNAL IDENTIFICATION, the processing includes EMBED a target data source, D, and run an inference process (QUERY MEMORY) on the results to see if D is sufficiently similar to a remembered case. If so, return the associated (remembered) tag. Otherwise, invoke EXTERNAL IDENTIFICATION and REMEMBER the results, if any. Correcting false positive cases is handled through the UNTAG operation that REMEMBERs that no tag should be returned.

The disclosed system and processes provides inference capabilities even when EXTERNAL IDENTIFICATION is replaced with a dummy process which always fails to produce results.

Each operation of the disclosed system and process is detailed below. At a high level, the system samples data with an unknown classification and embeds it into k-dimensional space using a Hankel matrix. This embedding space already contains known data with known classifications, also embedded via Hankel matrices. The system then determines whether the unknown data's embedding is sufficiently similar to any of the known embeddings, and outputs a proposed classification. In some embodiments, the system may also output a confidence estimate for the proposed classification.

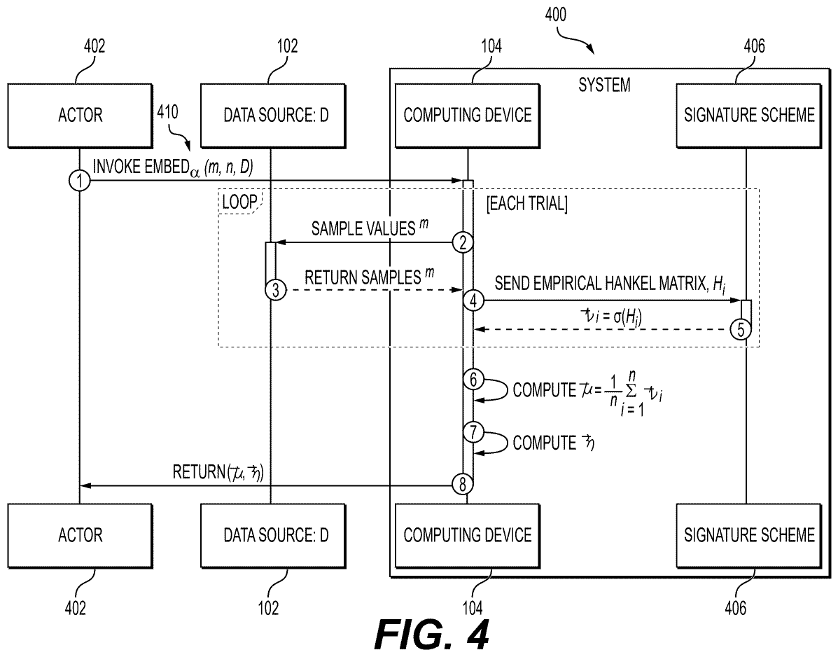

The embed process 410 is illustrated in FIG. 4 which may be invoked by an actor 402 (which may be a user of system 400). With a signature scheme 406, σ, and given a data source 102, D, parameter values for the sample size, m, and the number of trials, n: 1) Loop n times, once for each trial. Generically, in the i-th trial: A) Sample m values from the data source 102, D and return the samples. B) Optionally normalize each sampled string by a character-class mapping (e.g., replacing each digit with a canonical digit character and each letter with a canonical letter character), so that the Hankel matrix captures structural patterns rather than specific values (not shown). C) Construct an empirical Hankel matrix Hᵢ. D) Compute \vec{v}ᵢ=σ(Hᵢ)∈ [symbol] .
2) Compute the mean

$$\vec{μ} = \frac{1}{n} {\sum }_{i = 1}^{n} {\vec{v}}_{i} ,$$

together with a vector of standard deviations \vec{η} in each of the principal directions. 3) Return (\vec{μ}, \vec{η}) as an embedding, which may be returned to the actor 402 and/or the data source 102 by the computing device 104.

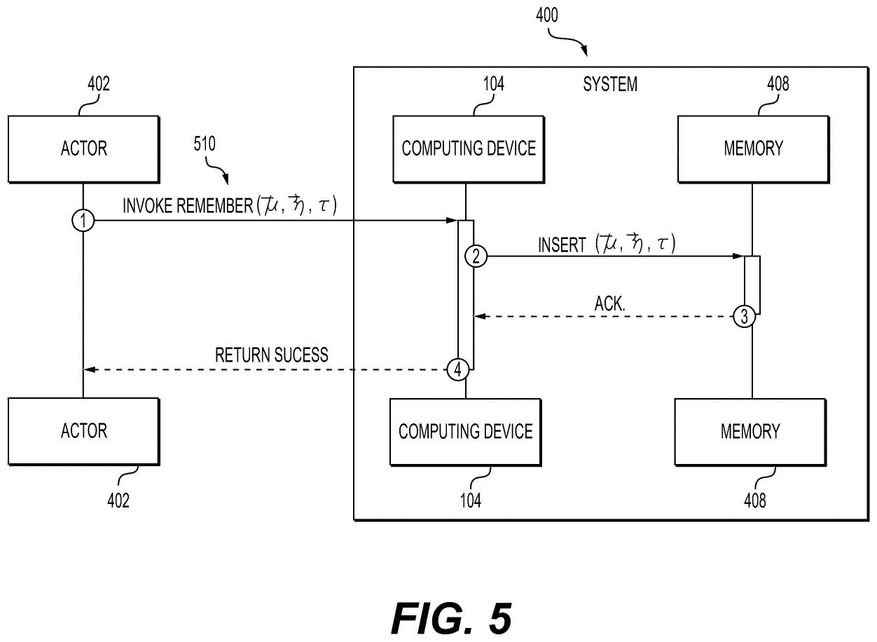

The Remember process 510 is illustrated in FIG. 5 which may be invoked by actor 402. Given an embedding, (\vec{μ}, \vec{η}), and an identifier class z: Insert or store (\vec{μ}, \vec{η}, τ) into memory 408, M in computing device 104.

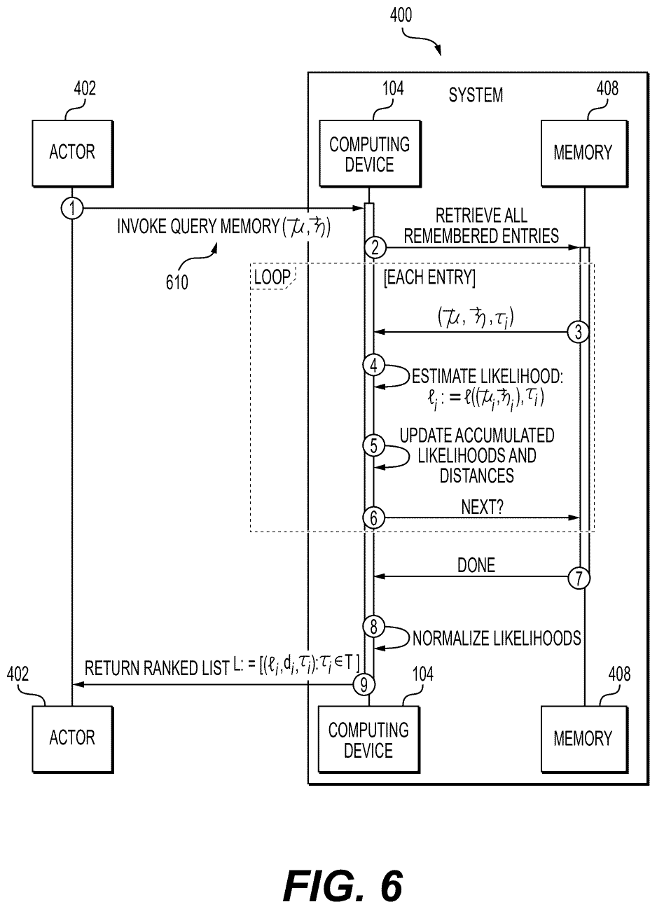

The Query Memory process 610 is illustrated in FIG. 6 which may be invoked by actor 402. Given an embedding, (\vec{μ}, \vec{η}): 1) Loop over remembered identifier triples (\vec{μ}ᵢ, \vec{η}ᵢ, τᵢ)∈M: a) Estimate the likelihood (\vec{μ}, \vec{η}) is sampled from (\vec{μ}ᵢ, \vec{η}ᵢ), b) Credit the likelihood to the identifier class τᵢ, c) Update the distance to the identifier class τᵢ. 2. Normalize identifier class likelihoods. 3) Return by computing device 104 a ranked list of all known identifier classes, which may be classifications, along with their corresponding likelihoods and distances.

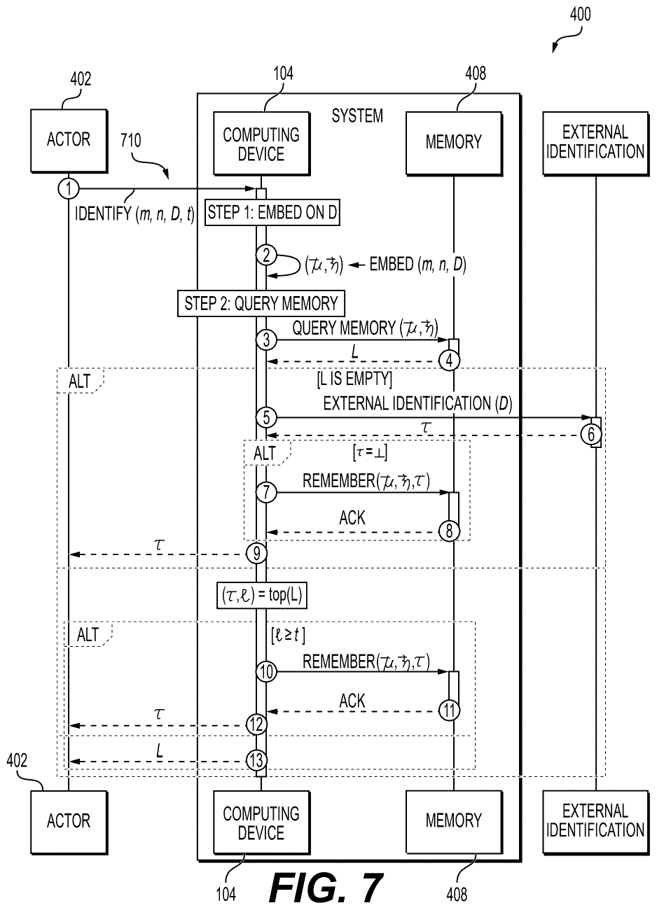

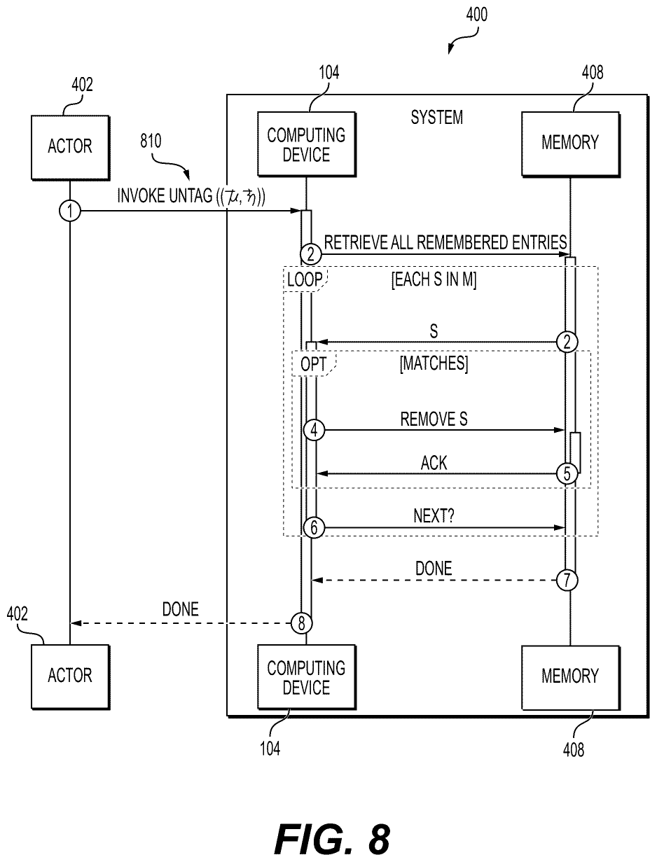

The Identify process 710 is illustrated in FIG. 7. Using a data source 102, D, sample-size, m, number of trials n, and threshold, t: 1) Invoke EMBED with parameters (m,n,D) to obtain (\vec{μ}, \vec{η}). 2) Invoke QUERY MEMORY on (\vec{μ}, \vec{η}) to obtain the most likely identifier class list, L. 3) If L is empty: a) Invoke EXTERNAL IDENTIFICATION on data source D to obtain possible identifier label τ. b) If τ is not ⊥ then invoke REMEMBER on (\vec{μ}, \vec{η}, τ). c) Return τ. 4) Otherwise, a) Let (τ, [symbol] ) be the top element of L. b) If [symbol] ≥t: Invoke REMEMBER on (\vec{μ}, \vec{η}, τ). Return τ. Return ⊥.

The Untag operation 810 is illustrated in FIG. 8. Given an embedding, (\vec{μ}, \vec{η}): 1) Remove (\vec{μ}, \vec{η},·) from M. 2) Invoke REMEMBER on (\vec{μ}, \vec{η}, τ).

Embodiments consistent with the presented invention utilize stable invariants of Hankel matrices to construct embeddings on, possibly transformed, sets of strings. Further, those constructing and maintaining classification functions on the embedding space are included. For example, various embodiments may: 1) Maintain a tagged (labeled) embedding derived from stable invariants of the Hankel matrix; 2) Associate embedding points or regions with data sources (e.g., database columns), with tags (labels) identifying data contents; 3) Modify the embedding labeling upon changes of data source tags (labels) manually or automatically, possibly via a user interface shown on a physical display; and 4) Predict identification labels for data sources using a likelihood measure on the labeled embedding.

### Example

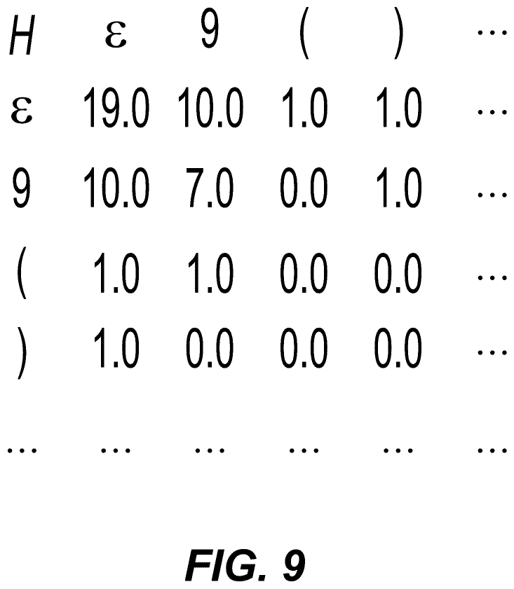

The following example uses concrete numbers computed from the algorithm described herein, with k=3 (top 3 singular values), n=2 trials, m=5 samples per trial, and a substring length limit of [symbol] =4. Digits are first replaced with the literal character 9 and letters with X, so that the Hankel matrix captures structural patterns rather than specific values. Each string is also wrapped with start and end boundary markers before processing.
Step 1: EMBED a phone number column. Consider a column with values: (212) 555-0147, (415) 555-0832, (718) 555-9201, (312) 555-4478, (650) 555-1369
After replacing digits with 9, these all have the form (999) 999-9999. The wrapped string (with boundary markers) has 18 characters in total.
Constructing the Hankel matrix. For each sample, we enumerate all substrings up to length 2 [symbol] =8 and, for each substring s, record every decomposition s=uv with |u|≤ [symbol] and |v|≤ [symbol] as an increment to H(u,v). The matrix is then divided by the number of samples to produce a per-sample average. With [symbol] =4, the resulting matrix is 32×32. Representative entries of the per-sample average include the entries shown in FIG. 9, where H(ε, ε)=19 reflects the number of substring positions (string length plus one), H(ε,9)=10 counts positions where a suffix beginning with 9 exists, and H(9,9)=7 counts the seven occurrences of 99 as a contiguous substring within the wrapped string.
Trial 1 (m=5 samples, all standard format): Computing the SVD of H₁ and taking the top k=3 singular values:

$${\vec{v}}_{1} = σ ( {H}_{1} ) = ( 2 8.73 , 4.22 , 4.09 )$$

Trial 2 (m=5 samples, four standard plus one alternate format 999-999-9999): The Hankel matrix H₂ differs due to the format variation:

$${\vec{v}}_{2} = σ ( {H}_{2} ) = ( 2 8.4 , 4.14 , 3.9 )$$

Aggregate: The embedding is:

$${\vec{μ}}_{p h o n e} = \frac{1}{2} ( {\vec{v}}_{1} + {\vec{v}}_{2} ) = ( 28.6 , 4.2 , 4. )$$

$${\vec{η}}_{p h o n e} = ( 0.24 , 0.06 , 0.13 )$$

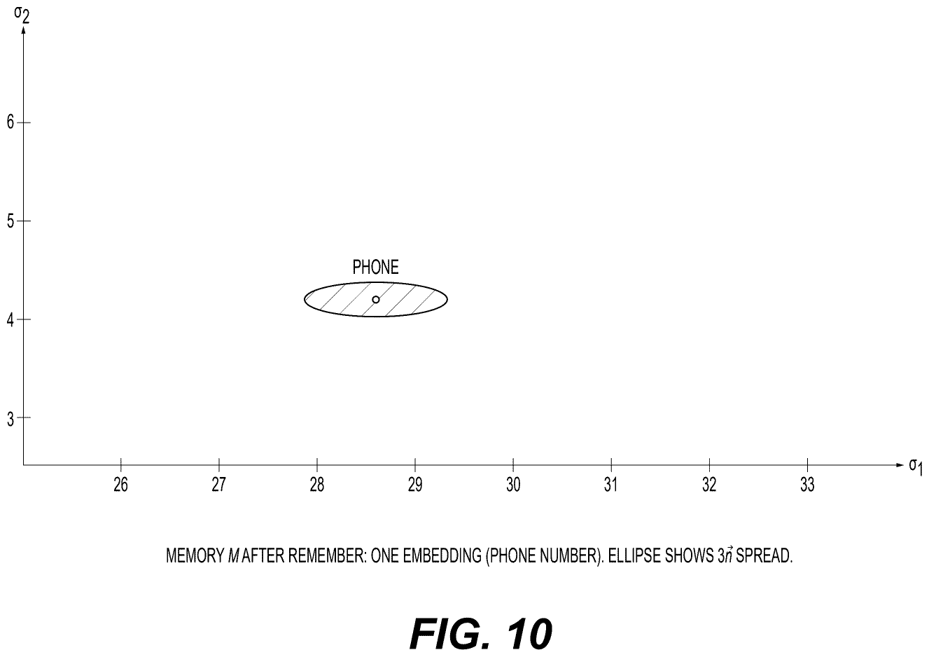

Step 2: REMEMBER. Store
((28.6,4.2,4.0), (0.24,0.06,0.13), Phone Number) in memory M as shown in FIG. 10.
Step 3: EMBED an email column. The column has values of varying length and structure. After replacing letters with X, these become strings such as XXXXX@XXXXXXX.XXX, XXX@XXXX.XXX, etc. The Hankel matrix captures the distinctive @ and · delimiters and the character-class distribution. Across two trials with different sample compositions:

$${\vec{μ}}_{e mail} = ( 3.17 , 5.5 , 4.3 ) ,$$

$${\vec{η}}_{e mail} = ( 0.37 , 0.11 , 0.08 )$$

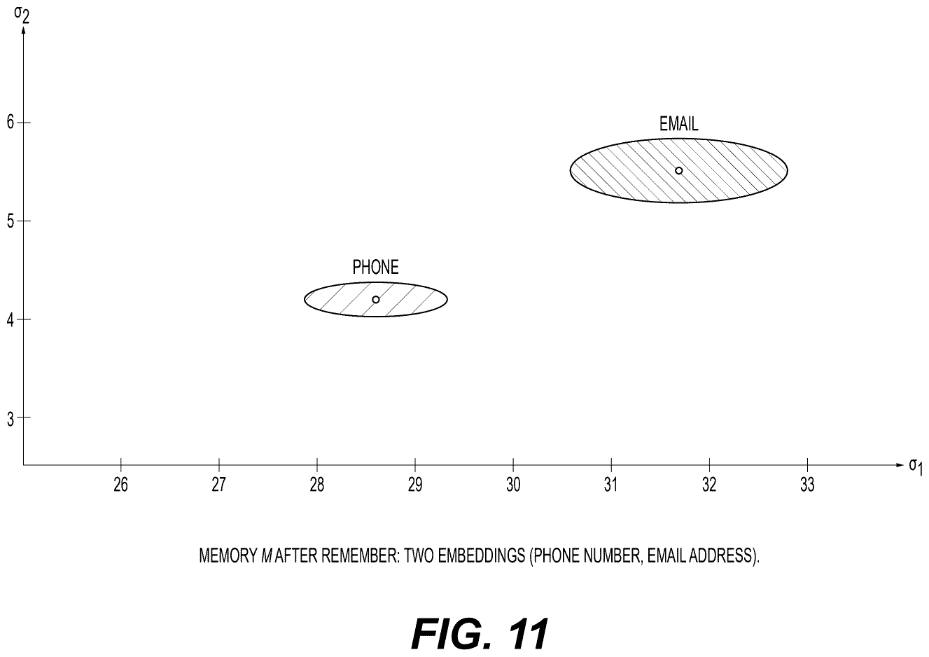

REMEMBER stores ((31.7,5.5,4.3), (0.37,0.11,0.08), Email Address) in M as shown in FIG. 11.
((31.7,5.5,4.3), (0.37,0.11,0.08), Email Address) in M.
Step 4: IDENTIFY a new column. A new column appears containing phone numbers in mixed formats: some as (999) 999-9999 and others as 999-999-9999. We invoke IDENTIFY with threshold t=0.7:
   1. EMBED produces across two trials:

$${\vec{μ}}_{n e w} = ( 28. , 4.2 , 3.7 ) ,$$

$${\vec{η}}_{n e w} = ( 0.13 , 0.07 , 0.03 )$$

2. QUERY MEMORY estimates likelihoods. For Phone Number, the component-wise distances in standard-deviation units (z-scores) are:

$$\vert \frac{28.6 - 28.0}{0.24} \vert = 2. 18 , \vert \frac{4.2 - 4.2}{0.06} \vert = 0. 45 , \vert \frac{4.0 - 3.7}{0.13} \vert = 1. 92$$

These are all within a few standard deviations, giving a high likelihood. For Email Address, the z-scores are much larger:

$$\vert \frac{31.7 - 28.0}{0.37} \vert = 9. 77 , \vert \frac{5.5 - 4.2}{0.11} \vert = 11.86 , \vert \frac{4.3 - 3.7}{0.08} \vert = 7. 46$$

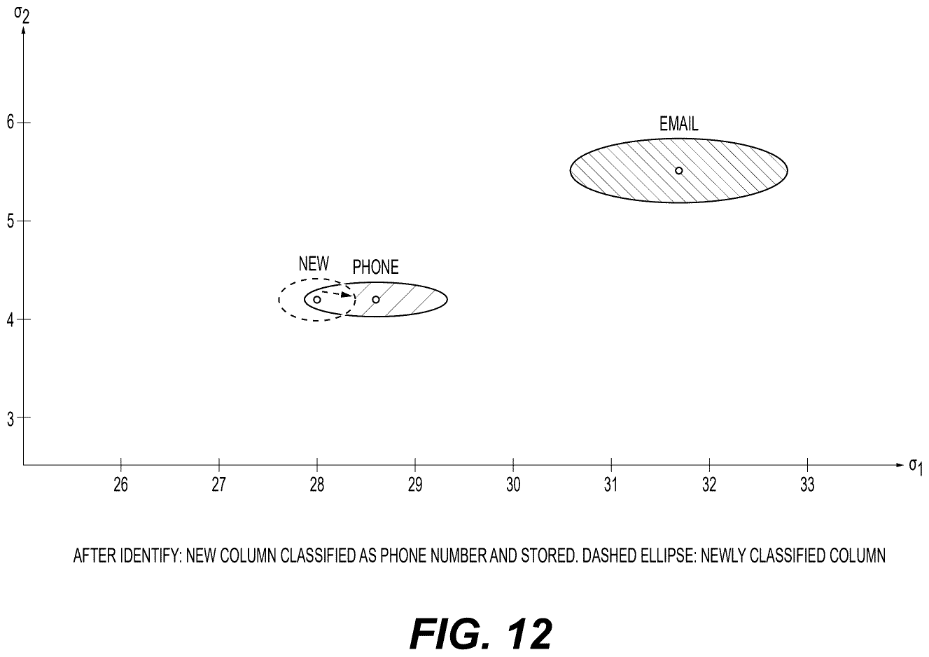

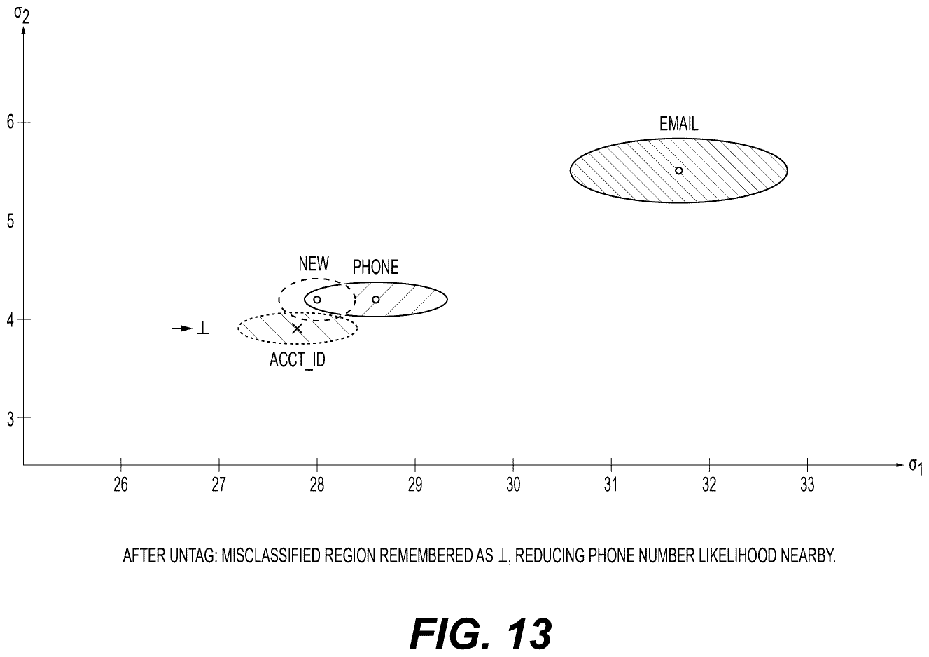

These are far beyond any reasonable threshold, giving negligible likelihood.
After normalization: Phone Number [symbol] ≈0.97, Email Address [symbol] ≈0.03.
3. Decision: 0.97≥0.7=t. Invoke REMEMBER on (\vec{μ}_{new}, \vec{η}_{new},Phone Number). Return Phone Number.
Projecting to the first two principal directions (σ₁, σ₂) as illustrated in FIG. 12.
Step 5: UNTAG a false positive. Suppose a column containing account codes like (ACC) 100-2345 is embedded as (27.8, 3.9, 3.8) and the system returns Phone Number with likelihood 0.78. A user corrects this:
   4. Remove ((27.8,3.9,3.8),·) from M.
   5. REMEMBER ((27.8,3.9,3.8), (0.20,0.05,0.04), ⊥).
Future columns embedding near (27.8, 3.9, 3.8) will find the ⊥ entry competing with Phone Number in QUERY MEMORY, reducing the likelihood that Phone Number is returned as illustrated in FIG. 13.

As noted above, conventional data source classification techniques involve applying regular expressions (e.g., a phone-number-detecting regular expression, a postal-code-detecting regular expression, an email-address-detecting regular expression, etc.) to each string in a data source and categorizing the data source according to which expression produces the most matches. These techniques require a knowledgeable practitioner to author each expression by precisely specifying character classes, quantifiers, alternations, and anchoring. When categories exhibit high variability, for example telephone numbers spanning domestic, international, and extension formats, the practitioner must anticipate and encode every structural variant, often requiring multiple iterations of authoring, testing, and revision. Adding a new category requires the same labor-intensive cycle anew. Data-driven alternatives such as active automata learning (e.g., Angluin's L* algorithm) can infer state machines from data but require an online oracle capable of answering membership and equivalence queries, presupposing either a knowledgeable practitioner or an existing authoritative system. Passive automata inference techniques avoid the oracle requirement but must observe enough samples to reconstruct all states and transitions of the generating automaton, which may be impractical when the underlying language is complex or data is limited. The dependence on practitioner expertise or oracle availability, the difficulty of achieving accurate coverage across structural variants, and the sample requirements of full automata reconstruction are technical problems for the computer systems implementing these conventional techniques.

In the instant application, the inventors have improved upon these conventional techniques by developing vector-based data source classification methods and systems that derive classification capability directly from labeled example data, without practitioner-authored patterns, without an online oracle, and without reconstructing a complete state machine. Known embeddings are produced by constructing a Hankel matrix operation from known data sets (e.g., telephone numbers, postal codes, email addresses, etc.), producing for each a mean vector and a standard deviation vector as a dispersion parameter that together define an ellipsoidal region in a k-dimensional embedding space. Because the goal is classification rather than reconstruction, the embedding need only capture enough distributional structure to distinguish categories, requiring substantially fewer samples than full automata inference. A given classification label may be associated with one or more ellipsoidal regions using the vector-based approach, so that structurally variable categories are represented as a union of regions rather than requiring explicit enumeration of variants. When an unknown data source needs to be categorized, embodiments of the described systems and processes compute a query point embedding from a data string of the data source, and for each stored embedding a measure of correspondence or similarity is computed between the query embedding and the ellipsoidal region parameterized by that stored embedding's mean vector as a location parameter and its standard deviation vector as a dispersion parameter characterizing the spread. The measures of correspondence or similarity are aggregated across all stored embeddings sharing a common classification label to produce a class-conditional score, and a classification label is assigned when the similarity or class-conditional score exceeds a predetermined threshold.

The vector-based approach of the disclosed embodiments further provides tunable tradeoffs between classification speed and precision that are unavailable in conventional techniques. The parameter k controls how many singular values are retained: a smaller k yields a faster, coarser embedding while a larger k preserves more structural detail, and k need only be large enough to separate the categories of interest. Additionally, randomized matrix decomposition techniques can approximate the top k singular values in time proportional to the product of the matrix dimensions and k, with accuracy degrading gracefully as a function of the first discarded singular value. The number of passes and degree of oversampling provide further controls. Together, the choice of embedding dimensionality and the use of approximate decomposition provide the implementing computer system with two independent mechanisms to allocate resources proportionally to task difficulty. These controls have no counterpart in regular-expression-based classification, where each expression must be evaluated in full regardless of how easily categories are distinguished.

These features of the disclosed embodiments directly tie the Hankel matrix operations to the implementing computer's ability to process and categorize unknown data sources and add meaningful, real-world technical limitations. The representation of each category as one or more ellipsoidal regions derived from example data eliminates the need for practitioner-authored pattern definitions and for an online oracle, while requiring fewer samples than full automata reconstruction. The tunable dimensionality and approximate decomposition allow the computer to balance computational cost against classification granularity proportionally to the complexity of the categories being distinguished. Viewing the described features as an ordered combination, the embodiments allow new categories to be introduced from labeled examples alone, accommodate structural variability without explicit enumeration, provide tunable precision-efficiency tradeoffs, and improve classification accuracy compared to regular-expression-based classification and automata inference. These are improvements in the technologies of data identification, data classification, and database processing.

Embodiments of the described systems and methods include novel technology for querying the memory with the unknown data source's query point, which memory stores the known embeddings, each of which includes a known mean vector and a known standard deviation vector corresponding to a known classification label (such as telephone numbers, postal codes, email addresses, etc.). Embodiments also include novel technology for estimating, for the unknown data source's query point, its degree or amount of similarity to the known embeddings. Embodiments further include novel technology for generating or determining a classification label for the unknown data source based on the degree or amount of similarity to the known embeddings. For example, if the unknown data source is most similar to the stored “telephone number” embedding, then the system classifies the unknown data source as a telephone-number data source.

These additional novel features and technologies directly tie and combine the Hankel matrix operations with the implementing computer's ability to process and categorize unknown data sources and add meaningful, real-world, technical limitations to the Hankel matrix operations.

Viewing the described features as an ordered combination, the embodiments described herein featuring the improved vector-based categorization of data sources allows the computer to use less computing resources and results in faster computation time, while also improving the accuracy of the classification results as compared to prior conventional systems and techniques, such as regular-expression-based data classification. These are also improvements in the technologies of data identification, data classification, and database processing.

It should be noted that the term “approximately” or “substantially” may be used herein and may be interpreted as “as nearly as practicable,” “within technical limitations,” and the like. In addition, the use of the term “or” indicates an inclusive or (e.g., and/or) unless otherwise specified.

Other implementations of the techniques herein will be apparent to those skilled in the art from consideration of the specification and practice of the embodiments disclosed herein. It is intended that the specification and various embodiments be considered as examples only.

What is claimed is:

1. A computer-implemented method for classifying a data source containing string values, the method comprising:
sampling a plurality of strings from the data source, the data source having an unknown classification;
constructing an empirical Hankel matrix from the plurality of sampled strings;
computing an embedding of the data source in a k-dimensional space by extracting the top k singular values of the empirical Hankel matrix;
repeating the sampling, constructing, and computing steps over n independent trials to produce n signature vectors, and aggregating the n signature vectors into a mean vector and a standard deviation vector to create a query point associated with the data source;
querying a memory with the query point, the memory storing known embeddings, each known embedding comprising a respective known mean vector and a respective known standard deviation vector having a known classification label, to estimate, for the query point, a similarity measure to the known embeddings; and
generating a classification label as a proposed classification of the data source, responsive to the similarity measure exceeding a predetermined threshold.

2. The method of claim 1, further comprising, for each of the sampled strings, replacing characters according to a character-class mapping to produce normalized strings.

3. The method of claim 2, wherein the empirical Hankel matrix is constructed from substring co-occurrence counts of the normalized strings, wherein each entry of the Hankel matrix records a count of co-occurrences of a prefix-suffix pair across substrings of the normalized strings up to a predetermined length limit.

4. The method of claim 1, further comprising storing the mean vector and the standard deviation vector of the data source associated with the generated classification label in the memory.

5. The method of claim 4, further comprising:
receiving an indication that the classification label is incorrect;
removing the mean vector, the standard deviation vector, and the classification label from the memory; and
storing the mean vector and the standard deviation vector with a null label in the memory.

6. The method of claim 1, further comprising, when the similarity measure does not exceed the predetermined threshold:
invoking an external identification process on the data source to obtain a classification label; and
storing the mean vector and the standard deviation vector together with the obtained classification label in the memory.

7. The method of claim 1, wherein when the similarity measure does not exceed the predetermined threshold, the method further comprises: obtaining a classification label via manual identification of a classification by a user.

8. The method of claim 1, wherein the predetermined threshold is configured to be set by a user.

9. A system for classifying a data source containing string values, the system comprising:
a computer-readable data storage device containing program instructions; and
a processor, operably connected to the computer-readable data storage device, that executes the program instructions to perform operations comprising:
sampling a plurality of strings from the data source, the data source having an unknown classification;
constructing an empirical Hankel matrix from the plurality of sampled strings;
computing an embedding of the data source in a k-dimensional space by extracting the top k singular values of the empirical Hankel matrix;
repeating the sampling, constructing, and computing steps over n independent trials to produce n signature vectors, and aggregating the n signature vectors into a mean vector and a standard deviation vector to create a query point associated with the data source;
querying a memory with the query point, the memory storing known embeddings, each known embedding comprising a respective known mean vector and a respective known standard deviation vector having a known classification label, to estimate, for the query point, a similarity measure to the known embeddings; and
generating a classification label as a proposed classification of the data source responsive to the similarity measure exceeding a predetermined threshold.

10. The system of claim 9, wherein the processor further executes program instructions to perform operations comprising, for each of the sampled strings, replacing characters according to a character-class mapping to produce normalized strings.

11. The system of claim 10, wherein the processor further executes program instructions to perform operations comprising constructing the empirical Hankel matrix from substring co-occurrence counts of the normalized strings, wherein each entry of the Hankel matrix records a count of co-occurrences of a prefix-suffix pair across substrings of the normalized strings up to a predetermined length limit.

12. The system of claim 9, wherein the processor further executes program instructions to perform operations comprising storing the mean vector and the standard deviation vector of the data source together with the returned classification label in the memory.

13. The system of claim 12, wherein the processor further executes program instructions to perform operations comprising:
receiving an indication that the classification label is incorrect;
removing the mean vector, the standard deviation vector, and the classification label from the memory; and
storing the mean vector and the standard deviation vector with a null label in the memory.

14. The system of claim 9, wherein the processor further executes program instructions to perform operations comprising, when the similarity measure does not exceed the predetermined threshold:
invoking an external identification process on the data source to obtain a classification label; and
storing the mean vector and the standard deviation vector together with the obtained classification label in the memory.

15. The system of claim 9, wherein when the similarity measure does not exceed the predetermined threshold, the operations further comprise: obtaining a classification label via manual identification of a classification by a user.

16. The system of claim 9, wherein the predetermined threshold is configured to be set by a user.

17. A non-transitory computer-readable medium storing instructions which, when executed by a processor of a system, cause the system to perform operations for classifying a data source containing string values, the operations comprising:
sampling a plurality of strings from the data source, the data source having an unknown classification;
constructing an empirical Hankel matrix from the plurality of strings;
computing an embedding of the data source in a k-dimensional space by extracting the top k singular values of the empirical Hankel matrix;
repeating the sampling, constructing, and computing steps over n independent trials to produce n signature vectors, and aggregating the n signature vectors into a mean vector and a standard deviation vector to create a query point associated with the data source;
querying a memory with the query point, the memory storing known embeddings, each known embedding comprising a respective known mean vector and a respective known standard deviation vector having a known classification label, to estimate, for the query point, a similarity measure to the known embeddings; and
generating a classification label as a proposed classification of the data source responsive to the similarity measure exceeding a predetermined threshold.

18. The non-transitory computer-readable medium of claim 17, wherein the instructions further cause the system to perform operations comprising, for each of the sampled strings, replacing characters according to a character-class mapping to produce normalized strings.

19. The non-transitory computer-readable medium of claim 18, wherein the instructions further cause the system to perform operations comprising constructing the empirical Hankel matrix from substring co-occurrence counts of the normalized strings, wherein each entry of the Hankel matrix records a count of co-occurrences of a prefix-suffix pair across substrings of the normalized strings up to a predetermined length limit.

20. The non-transitory computer-readable medium of claim 17, wherein the instructions further cause the system to perform operations comprising storing the mean vector and the standard deviation vector of the data source together with the returned classification label in the memory.

21. The non-transitory computer-readable medium of claim 20, wherein the instructions further cause the system to perform operations comprising:
receiving an indication that the classification label is incorrect;
removing the mean vector, the standard deviation vector, and the classification label from the memory; and
storing the mean vector and the standard deviation vector with a null label in the memory.

22. The non-transitory computer-readable medium of claim 17, wherein the instructions further cause the system to perform operations comprising, when the similarity measure does not exceed the predetermined threshold:
invoking an external identification process on the data source to obtain a classification label; and
storing the mean vector and the standard deviation vector together with the obtained classification label in the memory.

23. The non-transitory computer-readable medium of claim 17, wherein the instructions further cause the system to perform operations comprising:
when the similarity measure does not exceed the predetermined threshold, obtaining a classification label via manual identification of a classification by a user.

24. The non-transitory computer-readable medium of claim 17, wherein the predetermined threshold is configured to be set by a user.
